(19) United States
(12) Patent Application Publication
(10) Pub. No.: US 2012/0027376 A1
(43) Pub. Date: Feb. 2, 2012

(54) REPRODUCING APPARATUS, REPRODUCING METHOD, AND PROGRAM THEREFOR

(75) Inventors: Tsunemitsu Takase, Tokyo (JP); Toshitaka Tamura, Saitama (JP); Takafumi Azuma, Tokyo (JP); Yasushi Ikeda, Kanagawa (JP); Sou Fujii, Kanagawa (JP)

(73) Assignee: Sony Corporation, Tokyo (JP)

(21) Appl. No.: 13/187,708

(22) Filed: Jul. 21, 2011

(30) Foreign Application Priority Data
Jul. 27, 2010 (JP) P2010-168318

(51) Int. Cl. H04N 5/775

(52) U.S. Cl. 386/230; 386/E05.07

(57) ABSTRACT

A reproducing apparatus includes a reproducing section that reproduces 3D contents stored on a content-recording medium; and a display controller that displays a 3D content in 2D images during a predetermined time period after the completion of a jumping operation in the case where the jumping operation has been performed on the 3D images of the 3D content during the reproduction performed on the 3D images of the 3D content by the reproducing section.

### BACKGROUND

The present disclosure relates to reproducing apparatuses, reproducing methods, and programs therefor, and in particular, to a reproducing apparatus, a reproducing method, and a program therefor that enable switching from 2D display to 3D display that occurs in association with a jumping operation performed during the 3D-content reproduction to be performed without a feeling of strangeness.

In recent years, 3D movies in which images can be perceived in three dimensions have been gaining popularity. In addition, the sale of TV sets, in which 3D viewing can be enjoyed, has started. Therefore, 3D viewing has started to become widely used.

In the 3D-content reproduction by a reproducing apparatus, a 2D image is displayed in fast forward or in fast rewind by displaying only one of an image for left vision and an image for right vision. In this case, the display of images is changed from 2D display to 3D display just at the moment when the fast forward or the fast rewind is finished. Therefore, because the display of the images is suddenly changed to the 3D display in addition to the change of scenes owing to the termination of the fast forward or the fast rewind, a user becomes overly sensitive about the variations of parallax amounts, and he/she may often feels uncomfortable.

In the related art, there are disclosed techniques of gradually increasing parallax amounts when 2D display is changed into 3D display when switching from a 2D content to a 3D content in order that the change from the 2D display to the 3D display may be performed without a feeling of strangeness (Refer to Japanese Unexamined Patent Application Publication 2004-328566, for example).

### SUMMARY

However, in the related art, there is no disclosure of a technique that enables switching from 2D display to 3D display that occurs in association with a jumping operation performed during 3D-content reproduction to be performed without causing a feeling of strangeness.

The present disclosure is achieved with the above-described problems borne in mind, and enables switching from 2D display to 3D display that occurs in association with a jumping operation performed during 3D-content reproduction to be performed without a feeling of strangeness.

A reproducing apparatus according to an embodiment of the present disclosure includes a reproducing section for reproducing 3D contents stored on a content-recording medium; and a display controller for displaying a 3D content in 2D images during a predetermined time period after the completion of a jumping operation in the case where the jumping operation has been performed on the 3D images of the 3D content during the reproduction performed on the 3D images of the 3D content by the reproducing section.

A reproducing method according to an embodiment of the present disclosure includes a process in which a reproducing apparatus, which reproduces a 3D content stored on a content-recording medium, displays the 3D content in 2D images during a predetermined time period after the completion of a jumping operation in the case where the jumping operation has been performed on the 3D images of the 3D content during the reproduction.

A program according to an embodiment of the present disclosure causes a computer to function as a reproducing controller that controls the reproduction of a 3D content stored on a content-recording medium and as a display controller that displays a 3D content in 2D images during a predetermined time period after the completion of a jumping operation in the case where the jumping operation has been performed on the 3D images of the 3D content during the reproduction performed on the 3D images of the 3D content by the control of the reproducing controller.

In an embodiment of the present disclosure, a 3D content is displayed in 2D images during a predetermined time period after the completion of a jumping operation in the case where the jumping operation has been performed on the 3D images of the 3D content during the reproduction.

The reproducing apparatus can be a stand-alone apparatus or can be an internal block that constitutes part of an apparatus.

An embodiment of the present disclosure enables switching from 2D display to 3D display that occurs in association with a jumping operation performed during 3D-content reproduction to be performed without a feeling of strangeness.

### BRIEF DESCRIPTION OF THE DRAWINGS

FIG. 1 is a block diagram showing a configuration example of a reproducing apparatus according to an embodiment of the present disclosure;

FIG. 2 is a flowchart for explaining reproduction processing performed by the reproducing apparatus shown in FIG. 1;

FIG. 3A and FIG. 3B are diagrams showing the contents of data recorded as index files;

FIG. 4 is a diagram for explaining an analyzing process for analyzing the variation between a Base image before a jumping operation and a Base image after the jumping movement;

FIG. 5 is a diagram for explaining an analyzing process for analyzing the maximum value of the parallax amount corresponding to the protruding amount of an image;

FIG. 6A and FIG. 6B are imagery diagrams of images that are displayed by the reproduction processing shown in FIG. 2;

FIG. 7 is a flowchart for explaining another example of reproduction processing;

FIG. 8A and FIG. 8B are imagery diagrams of images that are displayed by the reproduction processing shown in FIG. 7;

FIG. 9A and FIG. 9B are diagrams showing imagery diagrams of images corresponding to the case where a user change channels; and

FIG. 10 is a block diagram showing a configuration example of a computer according to an embodiment of the present disclosure.

### DESCRIPTION OF THE PREFERRED EMBODIMENTS

### Configuration Example of Reproducing Apparatus According to Embodiment of Present Disclosure

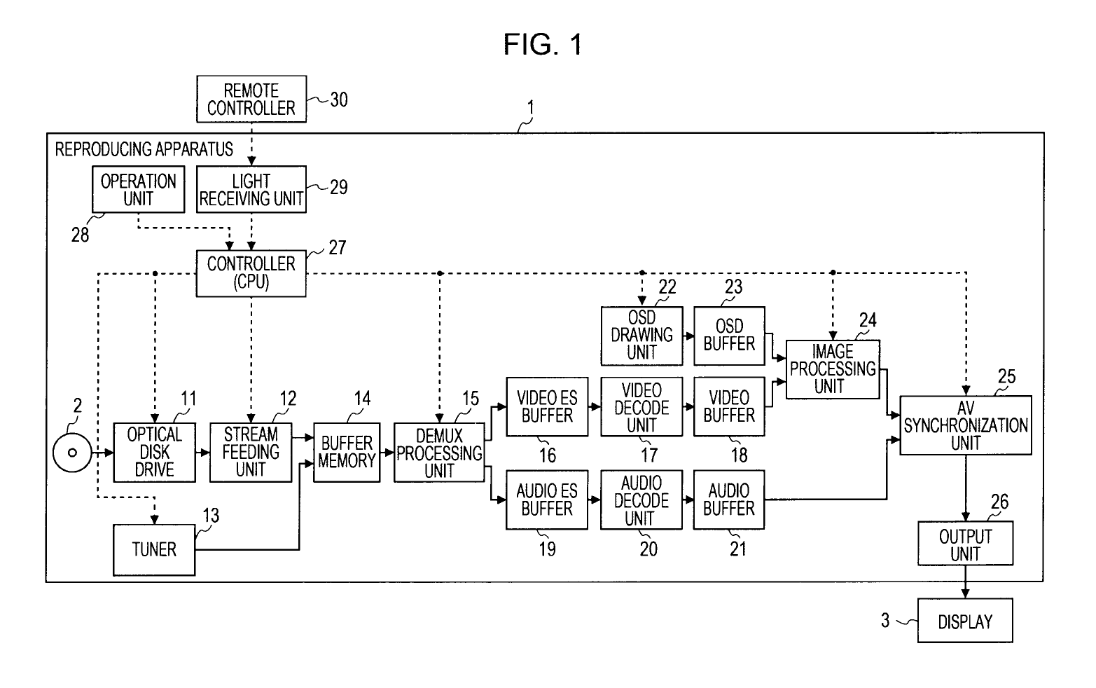

FIG. 1 shows a configuration example of a reproducing apparatus according to an embodiment of the present disclosure.

A reproducing apparatus 1 reproduces a 3D content recorded on an optical disk 2 (a content-recording medium), and displays 3D images of the 3D content on an external display 3. Although the expression “reproducing a content” recorded on the optical disk 2 used herein specifically means “reproducing the data of a content (content data)” recorded on the optical disk 2, the expression “reproducing a content” is used to refer to this in this specification. In addition, it goes without saying that the reproducing apparatus 1 is capable of reproducing a 2D content if the 2D content is recorded on the optical disk 2. In the case of a 2D content, an image presented to the right eye and an image presented to the left eye are equivalent to each other. On the other hand, in the case of a 3D content, an image presented to the right eye and an image presented to the left eye are different from each other, and because parallax exists between the image for the right eye and the image for the left eye, a stereoscopic image is perceived. In FIG. 1, solid lines indicate the flow of content data, and dashed lines indicate the flow of control signals.

In this embodiment, it will be assumed that the optical disk 2 used for the reproduction by the reproducing apparatus 1 is, for example, a BD-ROM. Here, the optical disk 2 can be a DVD (Digital Versatile Disc), or a Blu-ray (registered trade mark) Disc instead of the BD-ROM. In addition, the reproducing apparatus 1 can be a reproducing apparatus capable of reproducing a 3D content recorded on a semiconductor memory such as a flash memory, a hard disk, or the like instead of the optical disk 2. In other words, the types of content-recording media that can be used by the reproducing apparatus 1 are not limited to particular types.

An optical disk drive 11 drives the optical disk 2 under the control of a controller 27. A stream feeding unit 12 reads out an AV stream of a 3D content that is recorded on the optical disk 2 driven by the optical disk drive 11 as a recorded signal, and feeds the AV stream to a buffer memory 14.

A tuner 13 receives a broadcast signal within the frequency band of a predetermined channel determined by the controller 27 via an antenna (not shown), and feeds the AV stream of a resultant 3D content to the buffer memory 14. The buffer memory 14 holds the AV stream of the 3D content for a predetermined time period, and then feeds the AV stream to a Demux processing unit 15.

The Demux processing unit 15 extracts a video data packet, an audio data packet, a caption data packet, and the like on the basis of the PID (packet ID) of the AV stream fed by the buffer memory 14. The PID is an ID unique to each type of data that is included in a packet, and is attached to the packet.

The Demux processing unit 15 feeds the extracted video data (video ES) to a video ES buffer 16, and feeds the extracted audio data (audio ES) to an audio ES buffer 19. The abbreviation “ES” as used herein stands for “elementary stream”.

The video ES buffer 16 holds the video data fed by the Demux processing unit 15 for a predetermined time period, and then feeds the video data to a video decode unit 17. The video decode unit 17 creates image data for images for right vision (referred to as L images hereinafter) and images for right vision (referred to as R images hereinafter) by decoding the video data that has been encoded in a predetermined coding system such as MPEG2 (Moving Picture Experts Group phase 2), MPEG4, AVC (Advanced Video Coding), or the like. A video buffer 18 holds the image data for the L images and the R images obtained by decoding for a predetermined time period, and then feeds the image data to an image processing unit 24.

Image data of 3D contents is encoded in accordance with, for example, H264 AVC (Advanced Video Coding)/MVC (Multi-view Video Coding), and the encoded image data is compressed and recorded on the optical disk 2 so that the volume of the image data to be recorded can be made small.

In H264 AVC/MVC, a video stream called Base view video and a video stream called Dependent view video are defined. H264 AVC/MVC will be accordingly called MVC for short.

MVC performs coding by predicting relationships between images in a time sequence and relationships between streams (views).

In other words, in MVC, although the Base view video is not allowed to perform predictive coding that uses another stream as a reference image, the Dependent view video is allowed to perform predictive coding that uses the Base view video as a reference image. Therefore, image data of a 3D content can be obtained by, for example, performing coding in such a way that an L image is treated as Base view video and an R image as Dependent view video. In this case, because the predictive coding is performed on the R image on the basis of the L image, the data volume of the Dependent view video stream can be less than that of the Base view video stream.

In addition, the prediction of relationships between images in a time sequence is performed with regard to the Base view video because encoding is executed in accordance with H264/AVC. With regard to the Dependent view video, not only the prediction of relationships between views but also the prediction of relationships between images in a time sequence is performed. When the Dependent view video is decoded, it is necessary that the corresponding Base view video, which was referred to when the Dependent view video was encoded, has already been decoded.

As the image data of a 3D content, the data of the L image and the data of the R image can be individually recorded on an optical disk as MPEG-TSs different from each other. Alternatively, the data of these two images can be recorded as one MPEG-TS.

The audio ES buffer 19 holds audio data fed from the Demux processing unit 15 for a predetermined time period, and then feeds the data to an audio decode unit 20. The audio decode unit 20 creates voice data by decoding audio data encoded in accordance with a predetermined coding system such as MPEG or the like. An audio buffer 21 holds the voice data obtained by decoding the audio data for a predetermined time period, and then feeds the voice data to an AV synchronization unit 25.

An OSD drawing unit 22 creates OSD (On Screen Display) screens that are superimposed onto 3D images of a 3D content under the control of a controller 27, and then feeds the OSD screens to an OSD buffer 23. For example, the OSD drawing unit 22 creates an OSD screen for displaying a channel number, a volume, an OSD screen for displaying an elapsed time for reproduction, the current reproduction position in the entirety of the 3D content, and the like. The OSD buffer 23 holds image data of the OSD screens created by the OSD drawing unit 22 for a predetermined time period, and then feeds the image data to the image processing unit 24.

The image processing unit 24 obtains the image data held by the video buffer 18 and by the OSD buffer 23 under the control of the controller 27, and performs predetermined processes on the image data if necessary, and then feeds the image data on which the predetermined processes have been performed to the AV synchronization unit 25. The processes performed by the image processing unit 24 are, for example, a synthesis process for synthesizing an image of a 3D content and an OSD screen, a parallax changing process for changing the parallax amount between an L image and an R image, and the like.

The AV synchronization unit 25 synchronizes image data fed by the image processing unit 24 and voice data fed by the audio buffer 21 in accordance with PTS, and then feeds the synchronized image and voice data to an output unit 26. The PTS (Presentation Time Stamp) is time information used for reproduction.

The output unit 26 has a D/A converter built-in, and outputs the image data and voice data, which is fed from the AV synchronization unit 25, to the display 3 as analog or digital AV signals. The output unit 26 is equipped with output terminals such as a HDMI (High-Definition Multimedia Interface) output terminal for outputting the AV signals as HDMI signals, an output terminal for outputting the AV signals as component signals, and the like.

The display 3, which is connected to the output unit 26, can be, for example, a PDP (Plasma Display Panel) display, a television set including a liquid crystal display, or the like. In 3D-content reproduction, an L image and an R image are alternately displayed on the display 3. A viewer (user) watches 3D images of a 3D content wearing a pair of glasses for stereoscopic viewing. The pair of glasses for stereoscopic viewing has, for example, a shutter function of alternately shuttering left and right glasses so that the shutters for a left eye and a right eye alternately open and close in synchronization with L images and R images displayed on the display 3. A parallax is provided between an L image and an R image, and because the L image and the R image are viewed independently by the left eye and the right eye of the viewer, he/she can stereoscopically perceive the image displayed on the display 3.

The controller 27 controls a reproduced image displayed on the display 3 by controlling the reproducing operation of the reproducing apparatus 1 with the use of a control program recorded on a memory (not shown) in accordance with operation instructions issued from an operation unit 28 or a light receiving unit 29.

The operation unit 28 is equipped with, for example, a reproduction button for performing reproduction, a stop button for stopping the reproduction, and the like, and after receiving a user's operation, the operation unit 28 feeds an operation signal corresponding to the received user's operation to the controller 27. The light receiving unit 29 receives an operation signal fed from a remote controller 30 attached to the reproducing apparatus 1 via infrared data communication, or the like, and then feeds the operation signal to the controller 27.

The remote controller 30 feeds an operation signal corresponding to an operation button operated by the user to the light receiving unit 29 built-in in the reproducing apparatus 1 via wireless data communication such as infrared data communication.

The remote controller 30 is equipped with operation buttons used for 3D-content reproduction such as a reproduction button, a stop button, an FF (fast-forward) button, an FR (fast-rewind) button, a Next (next) button, a Prev (previous) button, a Flash+ button, and a Flash− button.

The FF (fast-forward) button, the FR (fast-rewind) button, the Next (next) button, the Prev (previous) button, the Flash+ button, and the Flash− button are buttons used for displaying an image that is located a predetermined number of frames in front of or behind the current image, that is, buttons used for a jumping operation.

The Next (next) button is a button used for moving the reproduction position to the head position of the chapter next to the currently reproduced chapter. The Prev (previous) button is a button used for moving the reproduction position to the head position of the currently reproduced chapter or the head position of the chapter previous to the currently reproduced chapter. The Flash+ button is a button used for moving the reproduction position to the position where the content would be reproduced a preset number of seconds later (for example, 15 seconds later) from the current reproduction position in ordinary reproduction. The Flash− button is a button used for moving the reproduction position to the position where the content was reproduced a preset number of seconds before (for example, 10 seconds before) from the current reproduction position. The FF (fast-forward) button and the FR (fast-rewind) button are buttons used for sequentially changing the reproduction position (reproduced image) forward and backward respectively while the buttons are being operated (pushed). On the other hand, as described above, the Next (next) button and the Prev (previous) button are buttons used for reproducing the content after moving the reproduction position to a specified position, and the Flash+ button is a button used for moving the reproduction position to the position where the content would be reproduced a preset number of seconds later from the current reproduction position in ordinary reproduction and the Flash− button is a button used for moving the reproduction position to the position where the content was reproduced a preset number of seconds before. Hereinafter, the generic name “Jump key” will be often used to refer to the Next (next) button, the Prev (previous) button, the Flash+ button, or the Flash− button.

The reproducing apparatus 1 is configured as described above.

In the reproducing apparatus 1, when the reproducing operation returns to ordinary reproduction after images (scenes) have changed considerably because the FF button, the FR button, or one of the Jump keys have been operated (pushed) during 3D-content reproduction, the 3D content can be displayed in 2D images for a certain time period. As a result, when the reproducing operation returns to ordinary reproduction, a feeling of strangeness that would occur by suddenly perceiving a stereoscopic image can be avoided.

### [Reproduction Processing Performed by Reproducing Apparatus 1]

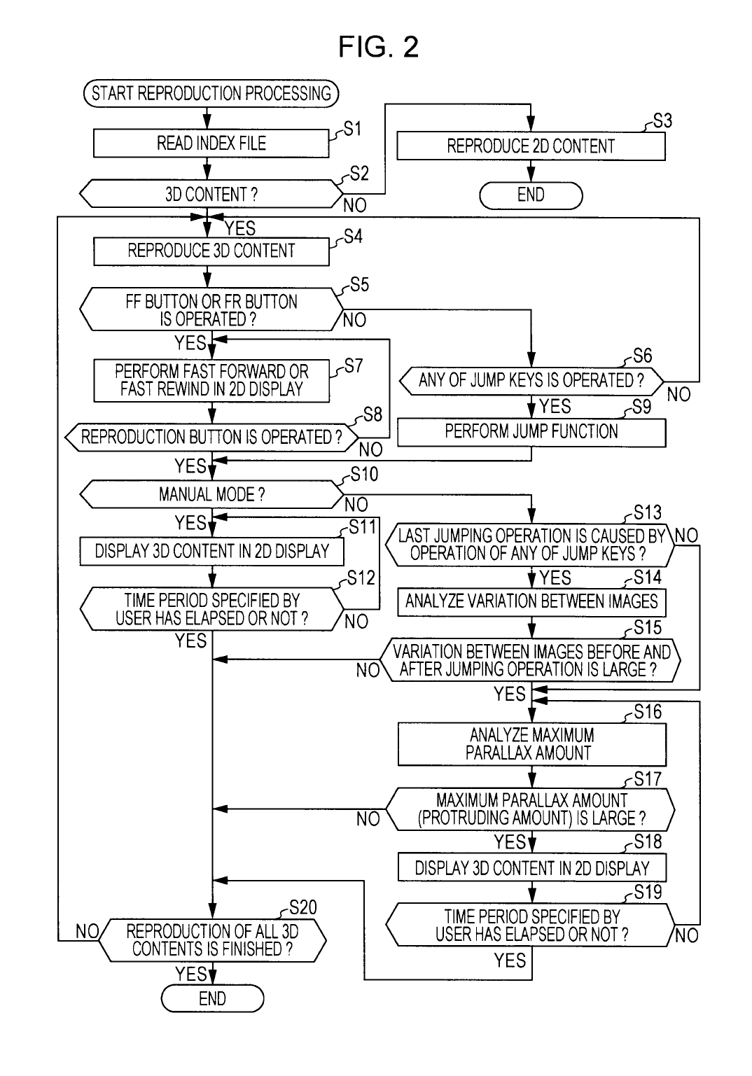

The reproduction processing performed by the reproducing apparatus 1 will be explained with reference to the flowchart of FIG. 2. The reproduction processing includes a process performed when the reproducing operation returns to the ordinary reproduction after images (scenes) change much because the FF button, the FR button, or one of the Jump keys is operated (pushed). This processing is started, for example, when a BD-ROM, which works as the optical disk 2, is mounted on the optical disk drive 11 as the optical disk 2.

Firstly, at step S1, the controller 27 of the reproducing apparatus 1 reads an index file recorded on the BD-ROM. At step S2, the reproducing apparatus 1 obtains information stored in the predetermined position of the index file, and judges whether a content recorded on the optical disk 2 is a 3D content or not with reference to the obtained information.

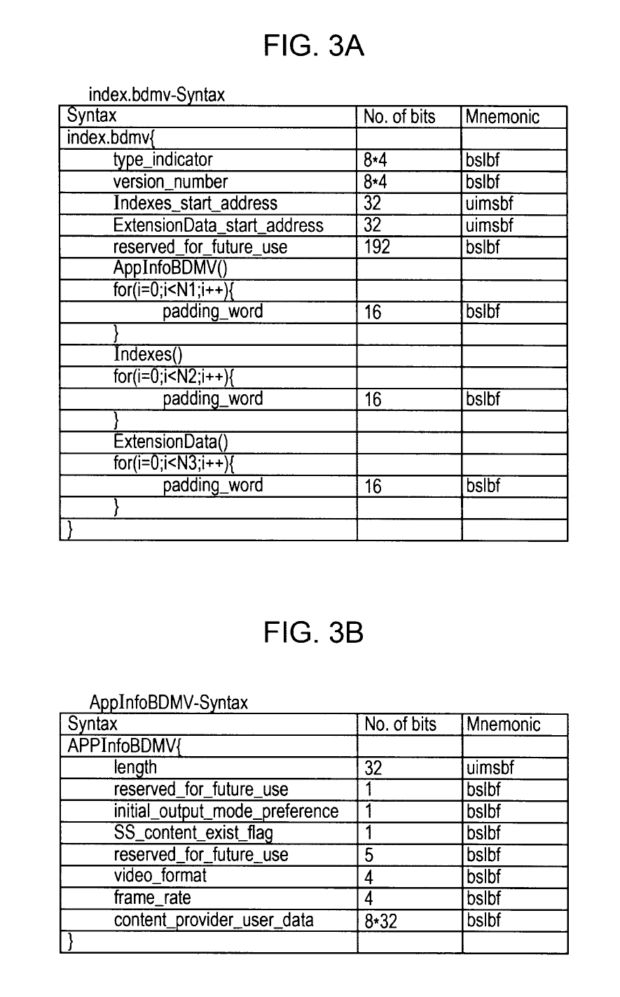

FIG. 3A shows the content of data recorded as an index file.

In the BD-ROM, BDMV directory is located under the root directory, and an index file (index. bdmv file) is located in BDMV directory.

FIG. 3A shows the data structure of the index file.

In the index file, there is AppinfoBDMV( ) that records information about a content. The data structure of AppinfoBDMV( ) is shown in FIG. 3B.

There is a flag “SS_content_exist_flag” in AppinfoBDMV( ). If the flag is “1”, this shows that a content stored on this BD-ROM is a 3D content. The controller 27 judges whether the content recorded on the optical disk 2 is a 3D content or not by checking the flag of “SS_content_exist_flag”. Information about a video format (video_format), information about a frame rate (frame_rate), and the like are also recorded in AppInfoBDMV( ).

To come back to FIG. 2, at step S2, if it is judged that the content recorded on the optical disk 2 is not a 3D content, the flow proceeds to step S3, and the reproducing apparatus 1 reproduces the content as a 2D content. When all the 2D contents recorded on the optical disk are reproduced, this processing is finished.

On the other hand, if it is judged that the content recorded on the optical disk 2 is a 3D content at step S2, the flow proceeds to step S4, and the reproducing apparatus 1 reproduces the content as a 3D content.

The flow of content data in the ordinary 3D-content reproduction will be briefly explained below.

An AV stream read out from the optical disk 2 is fed to the Demux processing unit 15 via the buffer memory 14. The AV stream is divided into a video ES and an audio ES by the Demux processing unit 15, and the video ES is fed to the video decode unit 17 via the video ES buffer 16. The audio ES is fed to the audio decode unit 20 via the audio ES buffer 19. In the video decode unit 17, the video ES is decoded, and the image data for an L image and the image data of an R image are created. In addition, in the audio decode unit 20, the audio ES is decoded, and voice data is created. The image data for the L image and the R image, and the voice data are output by the AV synchronization unit 25 in a predetermined timing in accordance with PTS, and the L image and the R image are displayed on the display unit 3 and at the same time the voice data is output from the display unit 3.

After the 3D-content reproduction starts, the controller 27 judges whether the FF button or the FR button is operated (pushed) or not at step S5. If it is judged that neither of the FF button nor the FR button is operated (pushed), the flow proceeds to step S6, and the controller 27 judges whether any of the Jump keys is operated (pushed) or not.

At step S6, if it is judged that none of the Jump keys are operated (pushed), the flow goes back to step S4. In other words, if none of the FF button, the FR button, and the Jump keys are operated, the ordinary 3D-content reproduction continues to be performed.

On the other hand, if it is judged that any one of the FF button and the FR button is operated at step S5, the flow proceeds to step S7, and the reproducing apparatus 1 performs fast forward or fast rewind in 2D display in accordance with the operated FF button or the FR button.

The 2D display performed at step S7 will be explained below.

If the FF button or the FR button is operated during the 3D-content reproduction, only one video stream of the L image and the R image, that is, a video stream recorded as Base view video (Base image), is read out by the stream feeding unit 12 under the control of the controller 27, and is fed to the Demux processing unit 15 via the buffer memory 14. In the fast-forward or fast-rewind reproduction, search for a desired image has priority over the stereoscopic visual effect of a image, therefore it is necessary to quickly read and reproduce (display) images. In this embodiment, it will be assumed that video the video data of an L image is recorded as Base view video. Therefore, only a video stream corresponding to the L image, which is a Base image, is fed to the Demux processing unit 15, and the video ES of the L image is fed to the video decode unit 17 via the video buffer 16. The video ES of the L image is decoded, and the image data of the L image is created at the video decode unit 17, and the image data is held by the video buffer 18.

The image processing unit 24 outputs a Base image and a Dependent image alternately, that is, outputs an L image and an R image alternately, in the ordinary reproduction, but in the fast-forward reproduction or in the fast-rewind reproduction, the image processing unit 24 outputs only Base images (L images), that is, outputs a Base image in the timing when a Dependent image (R image) would be output in the ordinary reproduction. Such reproduction as this is called 2D-content reproduction with the use of BB (Base-Base) outputs. At step S7, 2D-content reproduction is performed through reading out only Base images.

At step S8, the controller 27 judges whether a reproduction button is operated or not, and the processes at steps S7 and S8 are repeated until it is judged that the reproduction button is operated. In other words, the fast-forward 2D-content reproduction or the fast-rewind 2D-content reproduction is repeated until the reproduction button is operated. If it is judged that the reproduction button is operated at step S8, the flow proceeds to step S10.

At step S6, if it is judged that one of the Jump keys is operated, the flow proceeds to step S9, and the controller 27 causes the corresponding jumping function to be performed. In other words, the controller 27 causes a jumping operation to be performed so that the reproduction position changes in accordance with the operated button of the Next (next) button, the Prev (previous) button, Flash+ button, and Flash− button.

After the process at step S9 is finished, the flow also proceeds to step S10, and the controller 27 judges whether the current mode is the manual mode of two modes (the auto mode and the manual mode) or not.

The manual mode is a mode in which 2D display, where a 3D content is displayed in 2D images, is unconditionally performed during a time period specified by a user after the reproduction returns to the ordinary reproduction from the fast-forward reproduction caused by the operation of the FF button or the like. On the other hand, the auto mode is a mode in which a judgment on whether a 3D content is displayed in 2D display or not is (automatically) made in accordance with the parallax amount of a 3D image to be displayed after the reproduction returns to the ordinary reproduction.

At step S10, if it is judged that the current mode is the manual mode, the flow proceeds to step S11, and the reproducing apparatus 1 displays the 3D content in 2D display. The 2D display performed at step S11 is different from the above-described 2D display performed in the fast forward or fast rewind in that, in the 2D display performed at step S11, both Base image (Base view video) and Dependent image (Dependent view video) are read out from the optical disk 2. In the 2D display performed at step S11, however, the image processing unit 24 performs 2D display with the use of BB (Base-Base) outputs using only Base images held by the video buffer 18.

At step S12, the controller 27 judges whether a time period specified by the user has elapsed or not, and the process at step S11 is repeated until the time period specified by the user elapses. If it is judged that the time period specified by the user has elapsed at step S12, the flow proceeds to step S20.

Therefore, through processes at steps S11 and S12, 2D display of the 3D content is unconditionally performed until the time period specified by the user elapses after the operation of the FF button, the FR button, or one of the Jump keys. Therefore, when the reproducing operation returns to the ordinary reproduction, a feeling of strangeness that would be brought by suddenly perceiving a stereoscopic 3D image can be avoided.

On the other hand, at step S10, if it is judged that the current mode is not the manual mode, the flow proceeds to step S13, and the controller 27 judges whether the last jumping operation is caused by the operation of any of the Jump keys or not. In other words, whether the last jumping operation is performed not by the operation of the FF button or the FR button, but by the operation of one of the Jump keys is judged. In the jumping operation of image reproduction caused by the operation of the FF button or the FR button, it sometimes happens that the jump reproduction position is near to the previous reproduction position and an image reproduced at the jump reproduction position is not very different from the previous image. On the other hand, in the jumping operation of image reproduction caused by the operation of one of the Jump keys, it typically happens that the image reproduced at the jump reproduction position is very different from the previous image. Therefore, if the jumping operation of image reproduction is caused by the operation of one of the Jump keys, it is necessary to perform the process of step S14.

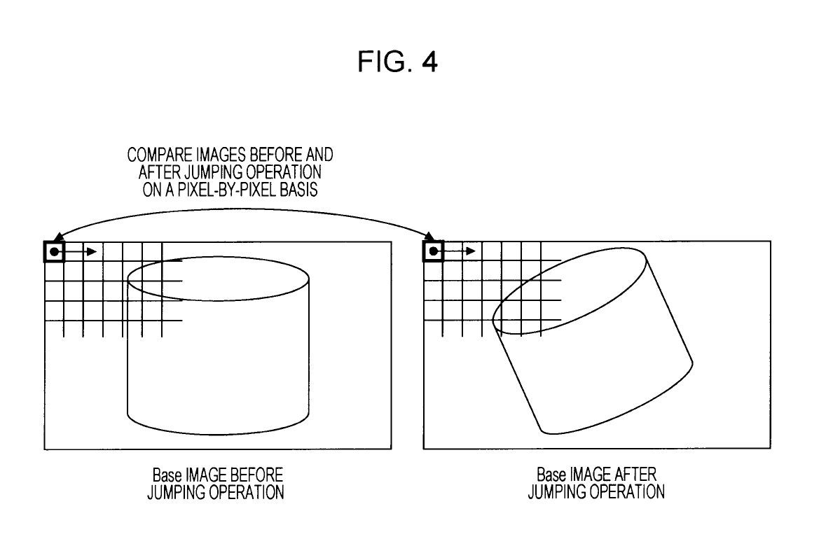

At step S13, if it is judged that the last jumping operation of image reproduction is caused by the operation of one of the Jump keys, the flow proceeds to step S14, in which the controller 27 causes the image processing unit 24 to analyze the variation between Base images before and after the jumping operation. The image processing unit 24 analyzes the variation between the Base images before and after the jumping operation under the control of the controller 27. To put it concretely, the image processing unit 24 compares the pixel value of each pixel of the Base image before the jumping operation with that of the corresponding pixel of the Base image after the jumping operation as shown in FIG. 4, and if the difference between both values is equal to or less than a predetermined value, it is judged that both values coincide with each other. In addition, if the percentage of the number of pixels, the values of which are judged to coincide with each other, to the total number of the pixels of the Base images is equal to or more than a certain percentage (for example, 70%), it is judged that the variation between two Base images are small (not large).

At step S15, the controller 27 judges whether the variation between the Base images before and after the jumping operation is large or not on the basis of the analysis result at the step S14. At step S15, if it is judged that the variation is small, the flow proceeds to step S20.

On the other hand, if it is judged that the variation is large at step S15, or if it is judged that the last jumping operation of image reproduction is not caused by the operation of one of the Jump keys at step S13, the flow proceeds to step S16.

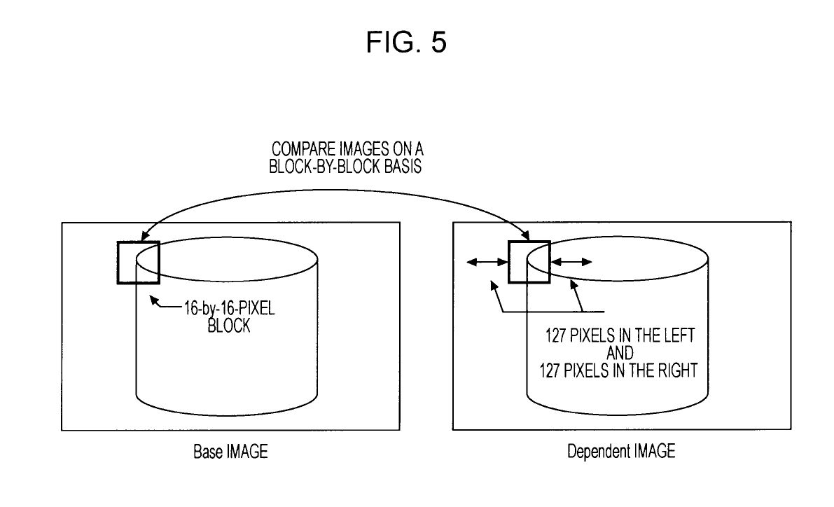

At step S16, the controller 27 causes the image processing unit 24 to analyze the maximum parallax amount corresponding to the maximum value of protruding amount of the image. The image processing unit 24 analyzes the maximum parallax amount between the reproduced Base image (L image) to be reproduced and the corresponding Dependent image (R image) under the control of the controller 27. To put it concretely, the image processing unit 24 divides each of the Base image and the Dependent image into plural blocks of a predetermined block size (for example, a block has 16-by-16 pixels) as shown in FIG. 5. The image processing unit 24 compares the Base image with the Dependent image on a block-by-block basis. Here, the image processing unit 24 detects the maximum parallax amount for each block of the Base image by comparing each block of the Base image with blocks of the Dependent image within the range that extends from the length of 127 pixels in the left to the length of 127 pixels in the right of the position of the block of the Dependent image corresponding to each of the Base image. In addition, the range that extends from the length of 127 pixels in the left to the length of 127 pixels in the right of the position of the block of the Dependent corresponding to each of the Base image can be accordingly changed to another optimal range depending on the situation. In other words, the length in the left or the length in the right of the position of the corresponding block of the Dependent image corresponding to each of the Base image is not limited to the length of 127 pixels.

At step S17, the controller 27 judges whether the protruding amount is large or not on the basis of the analysis result derived by the image processing unit 24. At step S17, if the maximum value of the maximum parallax amounts for blocks of the Base image calculated at step S16 exceeds a predetermined threshold, it is judged that the corresponding protruding amount is large. If it is judged that the protruding amount is small at step S17, the flow proceeds to step S20.

On the other hand, if it is judged that the protruding amount is large at step S17, the flow proceeds to step S18. Afterward, at steps S18 and S19, the reproducing apparatus 1 displays a 3D content in 2D display and judges whether the time period specified by the user has elapsed or not as in a similar way as at steps S11 and S12. At step S19, if it is judged that the time period specified by the user has not elapsed yet, the flow goes back to step S16. On the other hand, if it is judged that the time period specified by the user has elapsed, the flow proceeds to step S20.

Therefore, in steps S13 to S19, if the variation between 3D images before and after the jumping operation is not large, the 3D-content reproduction in 3D display is immediately restarted. In addition, even if the variation between the images before and after the jumping operation is large, but if the corresponding protruding amount is small, the 3D-content reproduction in 3D display is immediately restarted. In the case where the variation between the images before and after the jumping operation is large and at the same time the corresponding protruding amount is large, the 3D content is reproduced in 2D display during a time period specified by the user, and then the 3D-content reproduction in 3D display is restarted.

At step S20, the controller 27 judges whether the 3D-content reproduction is finished or not, that is, whether all the 3D contents have been read out from the BD-ROM or not. If it is judged that the reproduction of all the 3D contents is not finished at step S20, the flow goes back to step S4, and the process at step S4 and later are repeated. On the other hand, if it is judged that the reproduction of all the 3D contents is finished at step S20, the reproduction processing in FIG. 2 is finished.

### [Imagery Drawing of Reproduction Processing in FIG. 2]

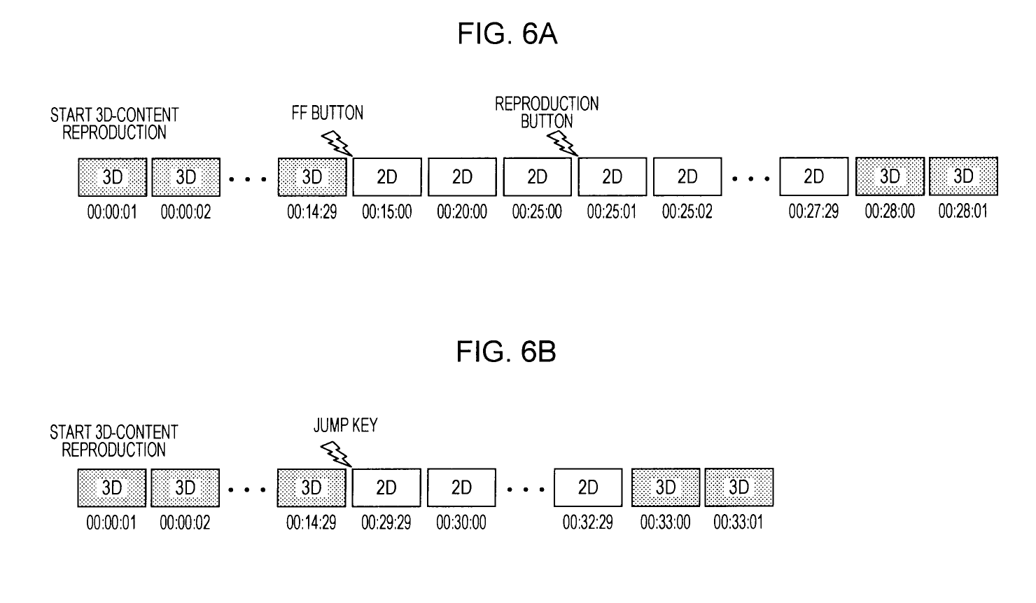

FIG. 6A and FIG. 6B are imagery diagrams of images that are displayed by the reproduction processing shown in FIG. 2 when the FF button, or one of the Jump keys is operated during 3D-content reproduction in the manual mode.

FIG. 6A is an imagery diagram of images that are displayed on the display 3 when the FF button is operated during the 3D-content reproduction.

It will be assumed that the FF button is pushed at the time [00:15:00] during the 3D-content reproduction. In this case, the reproducing apparatus 1 performs 2D display with the use of BB outputs while jumping over images that would be reproduced during a certain time period in the ordinary reproduction from the time [00:15:00]. In an example shown in FIG. 6A, the reproducing apparatus 1 performs 2D display while jumping over images that would be reproduced during 5 seconds in the ordinary reproduction.

It will be assumed that the reproduction button is operated at the time [00:25:00] during the fast-forward 2D-content reproduction. In this case, after performing 2D-content reproduction during the time period specified by the user (for example, 3 seconds in FIG. 6A) from the time [00:25:00], the reproducing apparatus 1 restarts 3D-content reproduction.

FIG. 6B is an imagery diagram of images that are displayed on the display 3 when one of the Jump keys is operated during 3D-content reproduction in the manual mode.

It will be assumed that the Flash+ button, which moves the reproduction position to a position where the content would be reproduced 15 seconds later in the ordinary reproduction, is operated at the time [00:14:29] during the 3D-content reproduction. In this case, the reproducing apparatus 1 moves the reproduction position to the position where the content would be reproduced 15 seconds later in the ordinary reproduction, that is, at the time [00:29:29], and then continues to perform 2D display during a time period specified by the user (3 seconds in FIG. 6B). At the time [00:33:00], that is, after the time period specified by the user has elapsed since the start time of 2D display [00:29:29], 3D display is restarted.

### [Modification of Reproduction Processing Shown in FIG. 2]

Next, another example of reproduction processing performed by the reproducing apparatus 1 will be explained below.

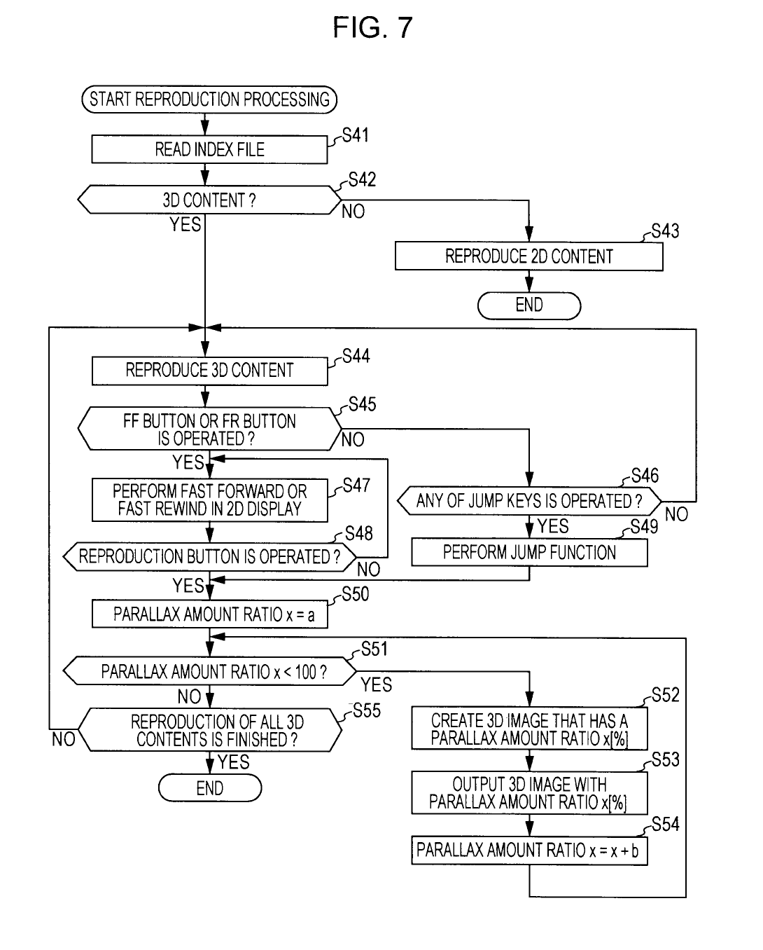

FIG. 7 is a flowchart showing another example of reproduction processing performed by the reproducing apparatus 1. In the reproduction processing shown in FIG. 7, when returning to the ordinary reproduction after images to be displayed change much because one of the Jump keys or the like is operated, the reproducing apparatus 1 does not immediately display original 3D images as they are, but displays 3D images that are adjusted so that their parallax amounts gradually increase. Here, the original 3D images are meant as 3D images that are recorded on the optical disk 2 with their parallax amounts as they are.

Because steps S41 to S49 in FIG. 7 are similar to steps S1 to S9 in FIG. 2, explanations about them will be omitted.

After the process at steps S48 or S49 is finished, that is, the process corresponding to the FF button, the FR button, or one of the Jump keys is finished, the image processing unit 24 substitutes a for a parallax amount ratio x[%} as an initial value at step S50. Here, the parallax amount ratio is the ratio of a changed parallax amount of an 3D image to the parallax amount of an original 3D image when the 3D image that has the changed parallax amount different from that of the original 3D image is created. For example, if x=50, the changed parallax amount is half the parallax amount of the original image. In addition, the initial value of the parallax amount ratio a can be set to 0, for example.

Next, at step S51, the image processing unit 24 judges whether the parallax amount ration x is smaller than 100 or not.

If it is judged that the parallax amount ratio x is smaller than 100 at step S51, the flow proceeds to step S52. Afterward, the image processing unit 24 obtain an original 3D image from the video buffer 18, and using the original 3D image, the image processing unit 24 creates a 3D image that has a parallax amount ratio x[%] relative to the parallax amount of the original 3D image. The video buffer 18 holds both Base image (L image) and Dependent image (R image) because it is just after the FF button, the FR button, or one of the Jump keys was operated.

At step S53, the reproducing apparatus 1 outputs the 3D image with the parallax amount ratio x[%] relative to the parallax amount of the original 3D image, which is created by the image processing unit 24, on the display 3. In other words, image data composed of the L image and the R image with the changed parallaxes, and voice data are output to the output unit 26 by the AV synchronization unit 25 in a predetermined timing in accordance with PTS. Afterward, the image data and the voice data are output from the output unit 26 to the display 3.

At step S54, the image processing unit 24 adds a ratio increment b to the parallax amount ratio x under the control of the controller 27, and the flow goes back to step S51, and the flow goes back to step S51. The ratio increment b is set to a predetermined value. For example, if a=0, and b=10, parallax amounts gradually get larger so that the size of the parallax amount of the tenth 3D image (a 3D image in the tenth field) is the same as that of the original 3D image.

If it is judged that the parallax amount ratio x is equal to or larger than 100 at step S51, the flow proceeds to step S55. At step S55, the controller 27 judges whether the 3D-content reproduction is finished or not, that is, whether all the 3D contents have been read out from the BD-ROM or not. If it is judged that the reproduction of all the 3D contents is not finished at step S55, the flow goes back to step S44, and the process at step S44 and later are repeated. On the other hand, if it is judged that the reproduction of all the 3D contents is finished at step S55, the reproduction processing shown in FIG. 7 is finished.

### [Imagery Drawing of Reproduction Processing in FIG. 7]

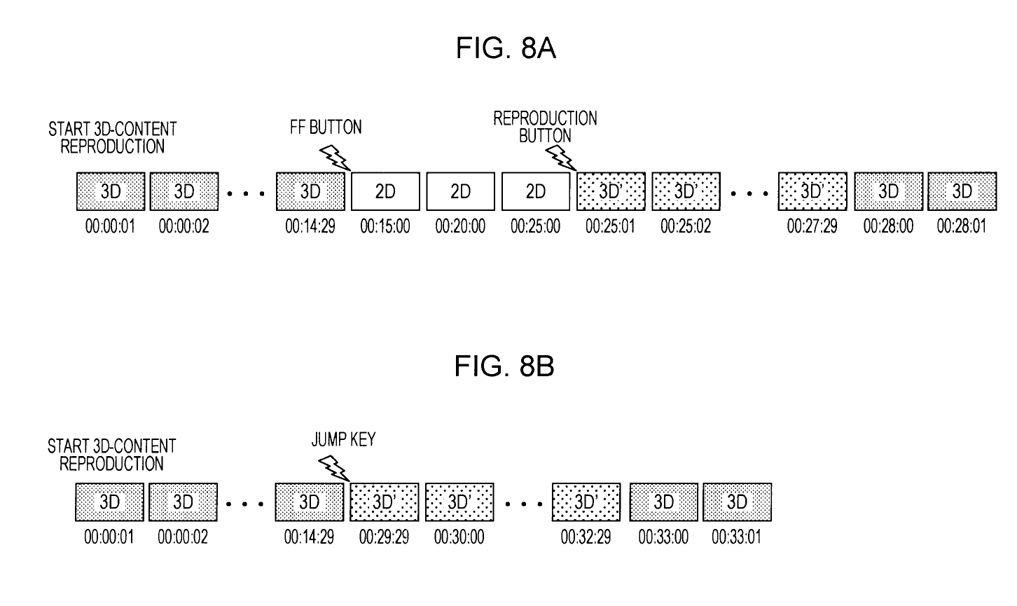

FIG. 8A and FIG. 8B are imagery drawings of images that are displayed by the reproduction processing shown in FIG. 7. Here, there is no manual mode nor auto mode in the reproduction processing in FIG. 7 unlike that in FIG. 2.

FIG. 8A is an imagery diagram of images displayed when the FF button is operated during 3D-content reproduction, while FIG. 8B is an imagery diagram of images displayed when one of the Jump keys is operated during 3D-content reproduction. Difference between FIG. 8A and FIG. 6A and difference between FIG. 8B and FIG. 6B will be respectively explained below. Timings of operations of the FF button, the reproduction button, and a Jump key in FIG. 8A and FIG. 8B are the same as those in FIG. 6A and FIG. 6B.

In FIG. 8A, instead of 2D images (2Ds) shown in FIG. 6A, 3D images whose parallax amount is x[%] (3D's shown in FIG. 8A) are displayed from the time [00:25:00] when the reproduction button is operated to the time [00:28:00] when the first original 3D image after the time [00:25:00] is displayed. In other words, the reproducing apparatus 1 displays 3D images whose parallax amount ration is x[%] for a predetermined time period from the time [00:25:00] (from the time [00:25:00] to the time [00:28:00], that is, for 3 seconds in FIG. 8A), and then displays the original 3D images.

The parallax amount ratio of a 3D image displayed at the time [00:25:01] and the parallax amount ratio of a 3D image displayed at the time [00:27:29] are different from each other. The parallax amount ratios of 3D images that are shown at the time [00:25:01] to the time [00:27:29] are adjusted to gradually increase from a[%] (the initial value) to nearly the parallax amount ratio of the original 3D images, that is, nearly 100[%]. The time period during which the 3D images with parallax amount ratios adjusted are displayed (3 seconds in FIG. 8A) is determined on the basis of the initial parallax amount ratio a and the ratio increment b.

In FIG. 8B, instead of 2D images (2Ds) shown in FIG. 6B, 3D images whose parallax amount ratio is x[%] (3D's in FIG. 8B) are displayed from the time [00:29:29] when one of the Jump keys is operated to the time [00:33:00] when the first original 3D image after the time [00:29:29] is displayed. In other words, the reproducing apparatus 1 displays the 3D images whose parallax amount ratio is x{%] for a predetermined time period from the time [00:29:29] (from the time [00:29:29] to the time [00:32:29], that is, for 3 seconds in FIG. 8B), and then displays the original 3D images.

The parallax amount ratio of a 3D image displayed at the time [00:29:29] and the parallax amount ratio of a 3D image displayed at the time [00:32:29] are different. The parallax amount ratios of 3D images are adjusted to gradually increase from the parallax amount ratio of the 3D image at the time [00:29:29], that is, a[%] (the initial value) to the parallax amount ratio of the original 3D images, that is, 100[%]. The time period during which the 3D images with parallax amount ratios adjusted are displayed (3 seconds in FIG. 8B) is determined on the basis of the initial parallax amount ratio a and the ratio increment b.

As described above, after any of the jumping operations, the reproducing apparatus 1 performs 2D display of a 3D content for a predetermined time period, or performs 3D display of 3D images whose parallax amounts are adjusted to gradually get back to the parallax amounts of original 3D images for a predetermined time period before displaying the original 3D images. The above-described behavior of the reproducing apparatus 1 enables a user (viewer) to easily follow the variations of parallax amounts caused by switching from 2D display to 3D display that occurs in association with a jumping operation performed during 3D-content reproduction, with the result that a feeling of strangeness and a sense of discomfort can be avoided.

### Application Example for Channel Switching

In the above descriptions, the processing in response to any of the jumping operations during the reproduction of 3D contents recorded on the optical disk 2 have been explained. In addition, there is a case where a 3D image is suddenly changed when a user changes the channel using the tuner 13. Therefore, processing similar to the processing in response to any of the jumping operations can be applied to the case where the user changes the channel.

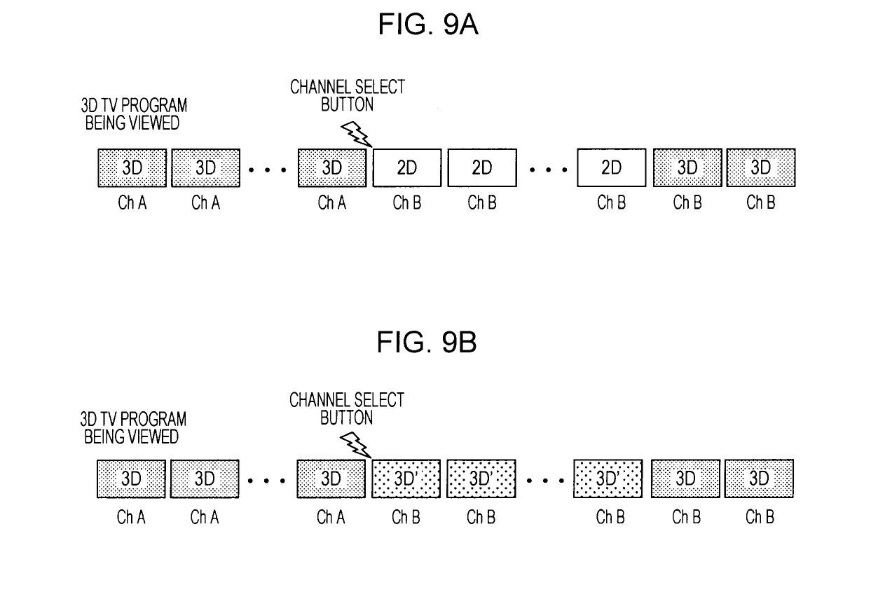

FIG. 9A and FIG. 9B show examples in which the processing similar to the above-described processing is applied to the case where the user changes the channel.

FIG. 9A is a counterpart diagram of FIG. 6A, and shows an example in which 2D display is performed for a time period specified by the user after the channel is changed, and afterward 3D display is performed. To put it concretely, after the channel select button for selecting channel B is selected during viewing channel A, a program of the channel B is displayed in 2D images for a time period specified by the user (for example, 3 seconds), and then 3D images are displayed.

FIG. 9B is a counterpart diagram of FIG. 8B, and shows an example in which 3D display of 3D images whose parallax amount ratios are adjusted so as to gradually get back to those of original 3D images for a time period specified by the user after the channel is changed. To put it concretely, after the channel select button for selecting channel B is selected during viewing channel A, a program of channel B is displayed in 3D images whose parallax amount ratios are adjusted for a time period specified by the user (for example, 3 seconds), and then 3D images whose parallax amounts are original ones are displayed.

### Other Application Examples

Heretofore, as measures against sudden switching of 3D images during reproduction owing to any of the jumping operations or the like, an example, in which 2D display is performed for a predetermined time period (FIG. 6A and FIG. 6B), and another example, in which 3D display of 3D images whose parallax amounts are adjusted so as to gradually get back to those of the original 3D images is performed (FIG. 8A and FIG. 8B), have been described. In addition, a combination of the above two examples can be employed. In other words, in the case of sudden switching of 3D images during reproduction, after 2D display is performed for a predetermined time period, 3D display of 3D images can be displayed for a predetermined time period so that the parallax amount ratios of the 3D images gradually get back to those of original 3D images.

As described above, even if a currently reproduced 3D image is suddenly switched to another image owing to any of the jumping operations or the like, the reproducing apparatus 1 enables a user (viewer) to easily follow the variations of parallax amounts because the parallaxes occur after the user recognizes the new content, with the result that a feeling of strangeness and a sense of discomfort can be avoided.

A sequence of processes described above can be realized either by hardware or software. In the case where the sequence of processes are realized by software, a program that includes the software is installed on a computer. Here, the computer can be a computer built into dedicated hardware or can be a computer that can perform a variety of function, for example, a general-purpose personal computer.

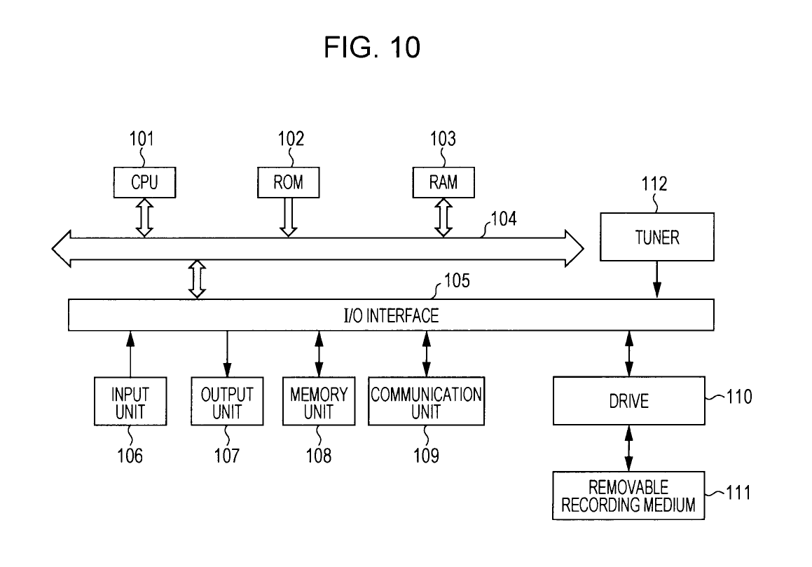

FIG. 10 is a block diagram showing a hardware configuration example of a computer that performs the above sequence of processes by a program.

In the computer, a CPU (Central Processing Unit) 101, a ROM (Read Only Memory) 102, and a RAM (Random Access Memory) 103 are connected with each other via a bus 104.

In addition, the bus 104 is connected with an I/O interface 105. An input unit 106, an output unit 107, a memory unit 108, a communication unit 109, and a drive 110 are connected with the I/O interface 105.

The input unit 106 includes a keyboard, a mouse, and a microphone. The output unit 107 includes a display and a speaker. The memory unit 108 includes a hard disk and a nonvolatile memory. The communication unit 109 includes a network interface. The drive 110 drives a removal recording medium 111 such as a magnetic disk, an optical disk, a magnet-optical disk, a semiconductor memory, or the like.

Tuner 112 receives a predetermined frequency band signals corresponding to a predetermined broadcast station, and feeds the signals to the CPU 101 and the like via the I/O interface 105.

In the computer configured as described above, the CPU 101 loads a program stored, for example, on the memory unit 108 onto the RAM 103 via the I/O interface 105 and the bus 104, and executes the program, with the result that the above-described sequence of processes is performed.

The program executed by the computer (the CPU 101) can be presented, for example, in the form of being recorded on the removable recording medium 111 (a package medium). As an alternative, the program can also be presented via a wired or wireless transmission medium such as a local area network, the Internet, or digital satellite broadcasting.

The program can be installed on the memory unit 108 of the computer from the removable recording medium 111 mounted on the drive 110 via the I/O interface 105. As an alternative, the program can be installed on the memory unit 108 from the communication unit 109 that receives the program via a wired or wireless transmission medium. As another alternative, the program can also be presented by installing the program on the ROM 102 or the memory unit 108 in advance.

The program executed by the computer can be a program that is executed in the time sequence described in this specification, can be a program some parts of which are executed in parallel, or can be a program that is executed in appropriate timing, for example, at the time when the program is called.

Embodiments of the present disclosure are not limited to the above-described embodiments, but various modifications may be made without departing from the spirit and scope of the present disclosure.

The present disclosure contains subject matter related to that disclosed in Japanese Priority Patent Application JP 2010-168318 filed in the Japan Patent Office on Jul. 27, 2010, the entire contents of which are hereby incorporated by reference.

What is claimed is:

1. A reproducing apparatus comprising:
a reproducing section that reproduces 3D contents stored on a content-recording medium; and
a display controller that displays a 3D content in 2D images during a predetermined time period after the completion of a jumping operation in the case where the jumping operation has been performed on the 3D images of the 3D content during the reproduction performed on the 3D images of the 3D content by the reproducing section.

2. The reproducing apparatus according to claim 1, wherein
the display controller is provided with:
a first mode in which the 3D content is unconditionally displayed in 2D images during a predetermined time period after the completion of the jumping operation, and
a second mode in which a judgment on whether the 3D content is displayed in 2D images or not is made in accordance with the parallax amount of a 3D image to be displayed after the completion of the jumping operation.

3. The reproducing apparatus according to claim 2, wherein the display controller also displays 3D images the parallax amounts of which gradually get back to the parallax amounts of the original 3D images of the 3D content during a predetermined time period after the completion of the jumping operation.

4. The reproducing apparatus according to claim 2, wherein the jumping operation includes at least one of operations performed using an FF button, an FR button, a Next (next) button, a Prev (previous) button, a Flash+ button, and a Flash− button.

5. A reproducing method comprising a process wherein a reproducing apparatus, which reproduces a 3D content stored on a content-recording medium, displays a 3D content in 2D images during a predetermined time period after the completion of a jumping operation in the case where the jumping operation has been performed on the 3D content during the reproduction performed on the 3D images of the 3D content.

6. A program that causes a computer to function
as a reproducing controller that controls the reproduction of a 3D content stored on a content-recording medium and
as a display controller that displays a 3D content in 2D images during a predetermined time period after the completion of a jumping operation in the case where the jumping operation has been performed on the 3D images of the 3D content during the reproduction performed on the 3D images of the 3D content by the control of the reproducing controller.
